(19) United States
(12) Patent Application Publication
(10) Pub. No.: US 2024/0375248 A1
(43) Pub. Date: Nov. 14, 2024

(54) FRICTION HOLDING STOP FOR A VISE

(71) Applicant: Kurt Manufacturing Company, Inc., Minneapolis, MN (US)

(72) Inventor: Tyler Mardaus, Aurora, CO (US)

(21) Appl. No.: 18/660,723

(22) Filed: May 10, 2024

Related U.S. Application Data
(60) Provisional application No. 63/501,902, filed on May 12, 2023.

(51) Int. Cl. B25B 1/10; B25B 1/02; B25B 1/24

(52) U.S. Cl. CPC B25B 1/103; B25B 1/02; B25B 1/2452; B25B 1/2484

(57) ABSTRACT

A vise assembly includes a base and a pair of side walls extending from the base having guideways. A jaw is configured for guided movement by the guideways. A friction holding stop is secured to the jaw configured to selectively and frictionally engage a surface of the base and inhibit sliding movement of the jaw on the guideways. The friction holding stop includes a support secured to the jaw including a cavity opening toward the surface of the base. A member is disposed within the cavity and movable toward and away from the surface, the member having a portion engageable with the surface of the base. A spring is configured to urge the member toward the surface of the base. An actuator is coupled to the member and the support, the actuator configured to selectively move the member away from the surface against a spring force from the spring.

### CROSS-REFERENCE TO RELATED APPLICATION

The present application is based on and claims the benefit of U.S. provisional patent application Ser. No. 63/501,902, filed May 12, 2023, the content of which is hereby incorporated by reference in its entirety.

### BACKGROUND

A common vise assembly in use is a two-station vise with a body with two longitudinal rails. A stationary jaw block is mounted to the rails between two movable jaws. A tubular or rotatable drive with threads connects the two movable jaws forming a compact axially adjustable floating assembly where rotation of the drive allows the movable jaws to move toward and away from each other, and in use, can clamp two workpieces and hold them in a stationary position where each workpiece is clamped between one of the movable jaws and the stationary jaw block located between the movable jaws.

In one particular application, it is desirable to secure the vise assembly in a vertical position where one of the movable jaws is located vertically above the other movable jaw. In such an application, it is also known to use a friction holding block that is secured to the vise body below the lower most movable jaw so as to prevent downward movement of the movable jaws and rotatable drive so as to allow them to function correctly when the vise assembly is mounted vertically.

### SUMMARY

A first aspect is a vise assembly having a base and a pair of side walls extending from the base having guideways, wherein inwardly facing surfaces of the base and side walls form a center recess. A jaw is configured for guided movement by the guideways. A friction holding stop is secured to the jaw configured to selectively and frictionally engage a surface of the base and inhibit sliding movement of the jaw on the guideways. The friction holding stop includes a support secured to the jaw, the support including a cavity opening toward the surface of the base. A member is disposed within the cavity and movable toward and away from the surface, the member having a portion engageable with the surface of the base. A spring is configured to urge the member toward the surface of the base. An actuator is coupled to the member and the support, the actuator being configured to selectively move the member away from the surface against a spring force from the spring.

A second aspect is a vise assembly having a base and a pair of side walls extending from the base having guideways, wherein inwardly facing surfaces of the base and side walls form a center recess. A first jaw is configured for guided movement by the guideways. A second jaw faces in a direction toward the first jaw and is configured for guided movement of the guideways. A friction holding stop is configured to selectively and frictionally engage a surface of the base and inhibit sliding movement of the first jaw on the guideways. The friction holding stop includes a bore, a spring, and a fastener extending through the bore and securing the friction holding stop to the first jaw on a side opposite the second jaw, the friction holding stop configured to slide on the fastener away from the first jaw and compress the spring.

### BRIEF DESCRIPTION OF THE DRAWINGS

FIG. 1 is a perspective view of a vise;

FIG. 2 is a front elevational view of the vise oriented vertically;

FIG. 3 is a perspective view of a vise assembly with portions removed;

FIG. 4 is an exploded view of a friction holding stop securable to a jaw nut;

FIG. 5 is a partial, sectional view of the vise of FIG. 1.

FIG. 6 is a sectional view of the friction holding stop in a first operating position;

FIG. 7 is a sectional view of the friction holding stop in a second operating position; and

FIG. 8 is a patronal sectional view of the vise assembly.

### DETAILED DESCRIPTION OF ILLUSTRATIVE EMBODIMENTS

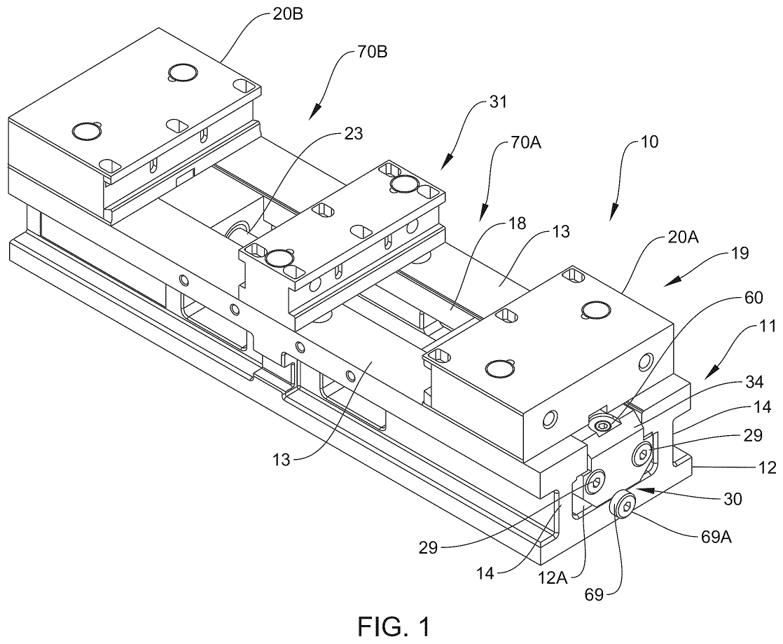

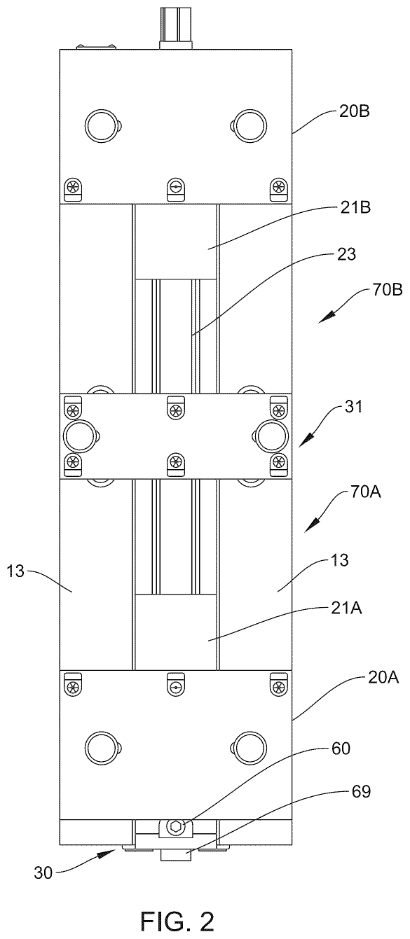

Referring to FIGS. 1 and 2, a vise assembly 10 has a vise body 11 that extends longitudinally along a central axis. The vise body 11 includes a base 12 and upstanding side rails or walls 14 on opposite sides thereof. The rails or walls 14 have upper flanges or guideways 13, which are typically co-planar. Inwardly facing surfaces of the base 12 and side walls 14 define a center recess 18 extending along a length of the vise body 11. The guideways 13 guide a vise jaw assembly indicated at 19. The vise jaw assembly 19 moves in the recess 18 in a floating manner as guided by the guideways 13 on the side walls 14.

The vise jaw assembly 19 is generally well known and includes a first jaw 20A and a second jaw 20B. The first jaw 20A includes a first jaw nut 21A that has a threaded bore in which a tubular drive or vise screw 23 is rotatably supported therein. The tubular drive or vise screw 23 has external threads on the outer surface that engage internal threads on the first jaw nut 21A. Similarly, a second jaw nut 21B of the second jaw 20B threadably mates with external threads on the outer surface of the tubular drive or vise screw 23. The threads are configured such that rotation of the tubular drive or vise screw 23 simultaneously moves the jaw nuts 21A, 21B toward or away from each other depending upon the direction of rotation.

Commonly, a stationary cross block or jaw 31 is fixedly secured to the side walls 14 for example on the guideways 13 between the first jaw 20A and the second jaw 20B such that a first workpiece can be selectively clamped between the first jaw 20A and the stationary cross block 31, while a second workpiece can be selectively clamped between the second jaw 20B and the stationary cross block or jaw 31.

As indicated in the Background section, it is often desirable to mount the vise assembly 10 vertically (FIG. 2) such as on a tower with possibly other vertically oriented vise assemblies. The tower can be rotatable such that an operator can repeatedly secure workpieces in the vise assemblies for machining thereof with a machine center not shown and not forming part of the invention. However, when mounted vertically, or at any substantial inclination, the vise jaw assembly 19 can slide downwardly upon the guideways 13 and at least partially out of the vise body 11. Therefore, in at least this situation, it is desirable to have a friction holding stop 30 secured to the vise body 11 wherein the friction holding stop 30 is configured to selectively and frictionally engage a surface of the vise body 11 so as to inhibit sliding movement of the jaw assembly 19 on the guideways 13 out of the vise body 11.

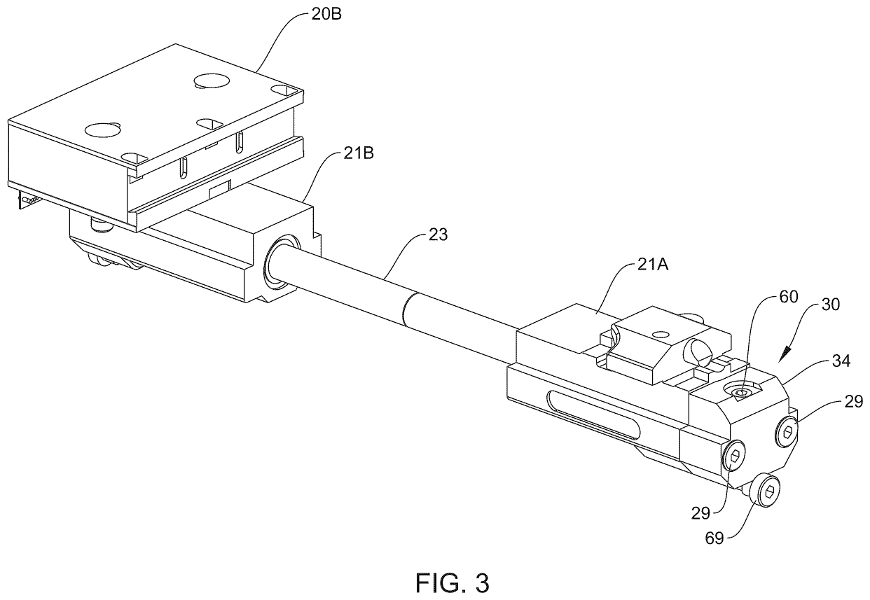

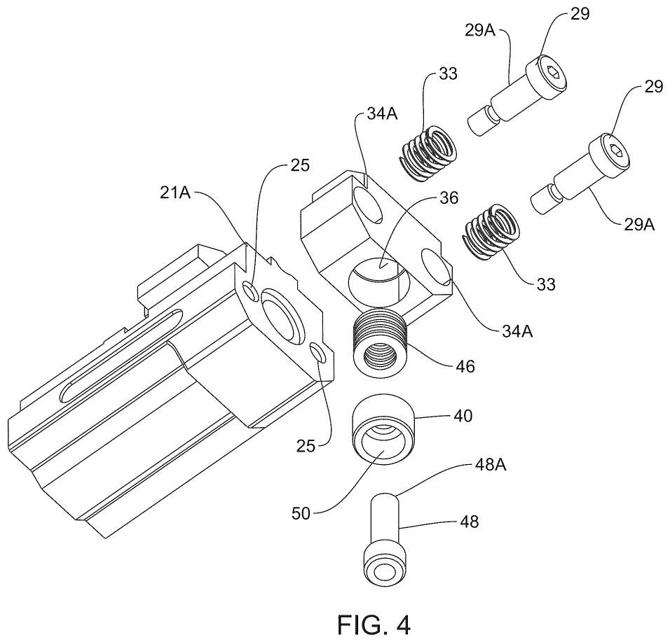

Referring to FIGS. 1-4, the friction holding stop 30 includes a support 34 secured to or formed integrally with from a single unitary body with the jaw nut 21A. In the embodiment illustrated, the support 34 is a separate element and at least one and preferably two spaced apart fasteners 29 are used to secure the support 34 to the jaw nut 21A with threaded apertures 25. In one advantageous embodiment, the fasteners 29 are received in bores 34A formed in the support 34 that allows the support 34 to slide upon the fasteners 29 on smooth shaft portions 29A thereof. Preferably, a spring 33 is received in an enlarged portion of the bore 34A where a first end of the spring 33 bears against an inner angular flange of the support 34, while a second end of the spring 33 is configured so as to bear against the head of the fastener 29. The fastener 29 extends through the bore 34A and secures the friction holding stop 30 to the jaw nut 21A. For reasons discussed below, the friction holding stop 30 is configured to slide on the fasteners 29 and separate from the jaw nut 21A so as to compress the springs 33.

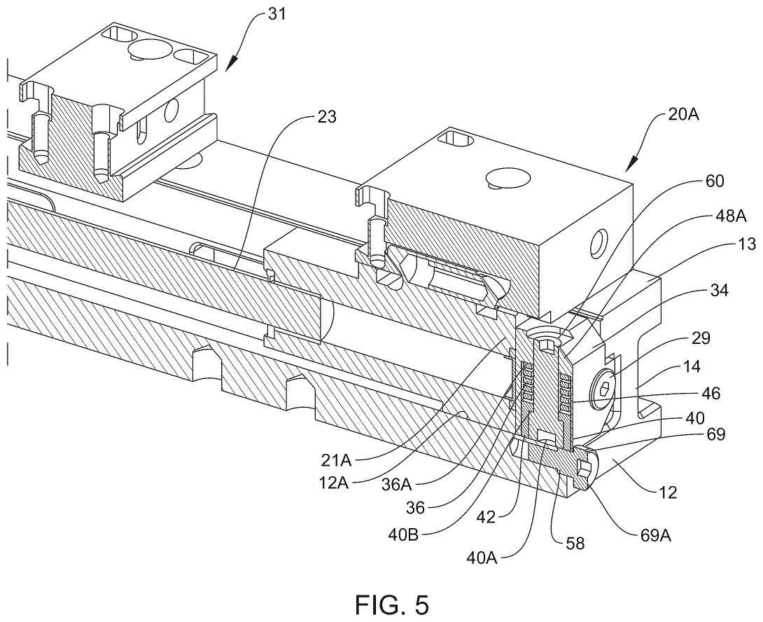

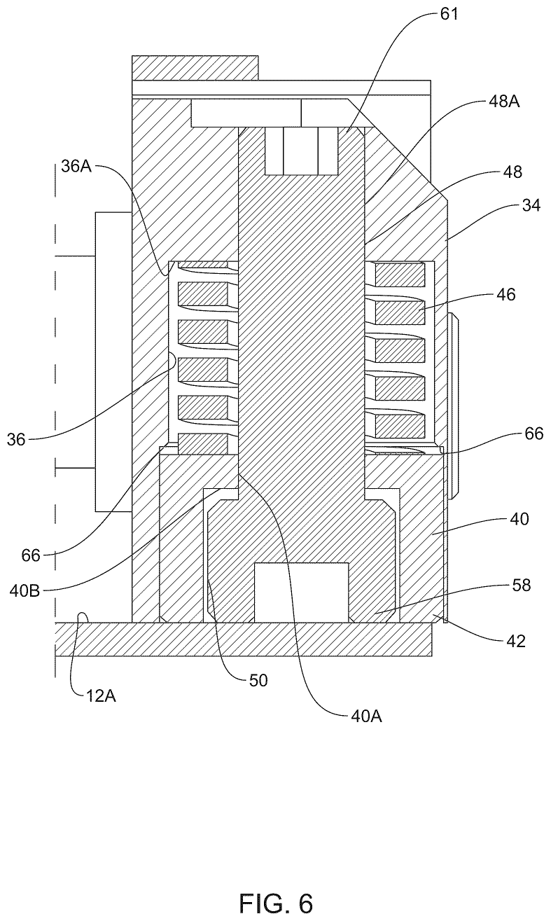

Referring also to FIGS. 5 and 6. a friction member 40 is movably supported in the support 34 and selectively engages the base 12, in particular, an upwardly facing surface 12A of the base 12. In the embodiment illustrated, the friction member 40 is disposed within a cavity 36 of size allowing it to move toward and away from the surface 12A of the base 12. The friction member 40 has a lower portion 42 engageable with the surface 12A of the base 12.

A spring 46 is disposed in the cavity 36 and configured to urge the friction member 40 toward the surface 12A of the base 12. In the embodiment illustrated, the spring 46 comprises a compression spring having a first end bearing against the friction member 40 on the end opposite the lower portion 42 and the second end of the spring 46 is configured to bear against an annular flange 36A formed in the cavity 36. An actuator 48 is coupled to the friction member 40 and the support 34. The actuator 48 is configured to move the friction member 40 away from the surface 12A against a spring force of the spring 46. In the embodiment illustrated, the actuator 48 can comprise a threaded fastener that extends through the spring 46 and a bore 40A provided in the friction member 40 wherein an end 48A of the threaded fastener 48 threadably engages the support 34. An enlarged head of the fastener 48 is received in a recess 50 of the friction member 40 where the head of the actuator 48 is of size so as to bear against an inner annular flange 40B of the friction member 40 when it is desired to move the friction member 40 away from the surface 12A against the spring force of the spring 46.

In a preferred embodiment, the actuator 48 such as the threaded fastener includes a friction end 58 configured to selectively engage the surface 12A of the base 12. Hence in a preferred embodiment, actuator 48 has a length that allows the friction end 58 to selectively engage the surface 12A of the base 12, while also is of length such that the actuator 48 can be operated so as to lift the friction member 40 off of the surface 12A of the base 12 when it is desired that the friction end 58 does not engage the surface 12A of the base 12. If embodied as a threaded fastener, the actuator 48 can include an end 61 opposite the friction end 58 that is configured to receive a tool such as a Allen wrench, screwdriver, socket or the like allowing the fastener 48 to be rotated so as to either force the friction end 58 to engage the surface 12A of the base 12 or, rotated to lift the friction member 40 off of the surface 12A. If desired, the cavity 36 can include an inwardly extending flange 66, such as an annular flange. The extending flange 66 is configured such that the friction member 40 will engage the flange 66 when the actuator 48 is operated to lift the friction member 40 off of the surface 12A of the base 12. The flange 66 thus provides a stop or limit as to how far the friction member 40 will be lifted off the surface 12A. Engagement of the friction member 40 of the flange 66 provides a tactile indication to the operator that the friction member 40 is no longer engaging the surface 12A of the base 12.

Various operating states can be obtained using the friction holding stop 30. In a first operating state, illustrated in FIG. 6, the actuator 48 is operated such that the friction member 40 is urged downward by the spring 46 so that friction is created between the portion 42 and the surface 12A. For instance, if embodied as a threaded fastener, the actuator 48 is rotated such that the head is free of engagement with the friction member 40 and does not engage the surface 12A, or does not engage the surface 12A with very much friction. In this configuration, the friction force between the friction member 40 and the surface 12A is sufficient to hold the vise assembly 19 in place against the force of gravity thereby preventing the vise assembly 19 and workpieces from sliding when the vise assembly 10 is in an inclined or vertical position. In other words, the friction holding stop 30 will hold the vise assembly 19 and workpieces in place but will still allow for a sliding motion when the vise screw 23 is rotated to set the location of the movable jaws 20A, 20B.

In the second configuration of the friction holding stop 30, also illustrated by FIG. 6, the actuator 48 is operated such that the friction end 58 sufficiently engages the surface 12A such that the amount of friction generated between the friction end 58 and the surface 12A inhibits any movement of the friction holding stop 30 relative to the base 12, and thus also inhibits any movement of the vise assembly 19 from sliding on the base due to gravity. In this position the friction holding stop 30 is fixedly, but releasably secured to the base 12.

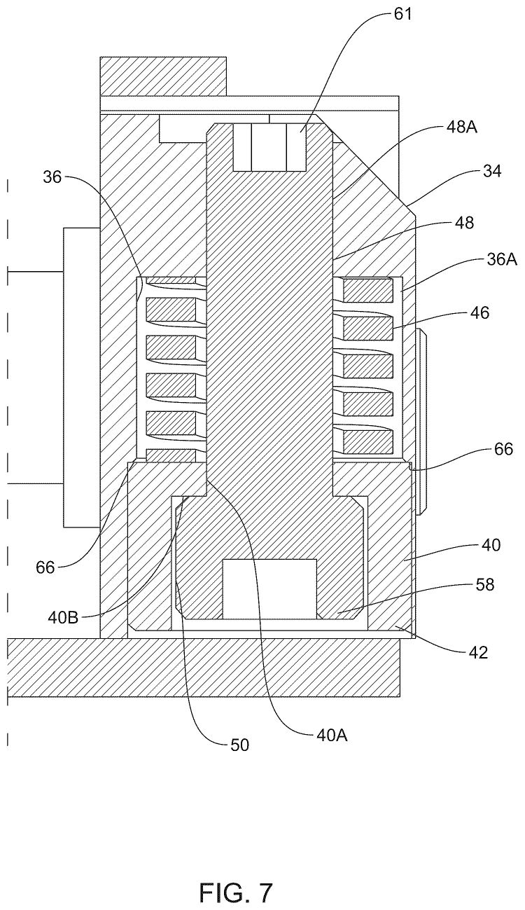

In the next configuration of the friction holding stop 30 illustrated in FIG. 7, the actuator 48 is operated so as to lift the friction member 40 away from the surface 12A so as to remove all or substantially all friction there between. If embodied as a threaded fastener, the actuator 48 is rotated in a direction opposite of that which secured the friction end 58 against the surface 12A. If the extending flange 66 is provided, the actuator 48 can be operated until the friction member 40 engages the extending flange 66 thereby providing the tactile indication that the friction member 40 has been sufficiently lifted from the surface 12A.

With the actuator 48 lifting the friction member 40 completely off the surface 12A or substantially off the surface 12A there is not much friction between the friction member 40 and the surface 12A. With the friction at least minimized, the vise assembly 19 or portions thereof can be then removed from the vise body 11. However, in this situation, the friction holding stop 30, jaws 20A, 20B and the vise screw 23 could slide significantly with respect to the base 12 in an uncontrolled manner. So as to prevent this, a stop element can be provided so that the friction holding stop 30 does not slide off of the base 12. For instance, in one convenient embodiment, a fastener 69 (FIGS. 1 and 5) threadably mates with the base 12 and has an enlarged head 69A to form a flange which would inhibit the support 34 from sliding off the base 12.

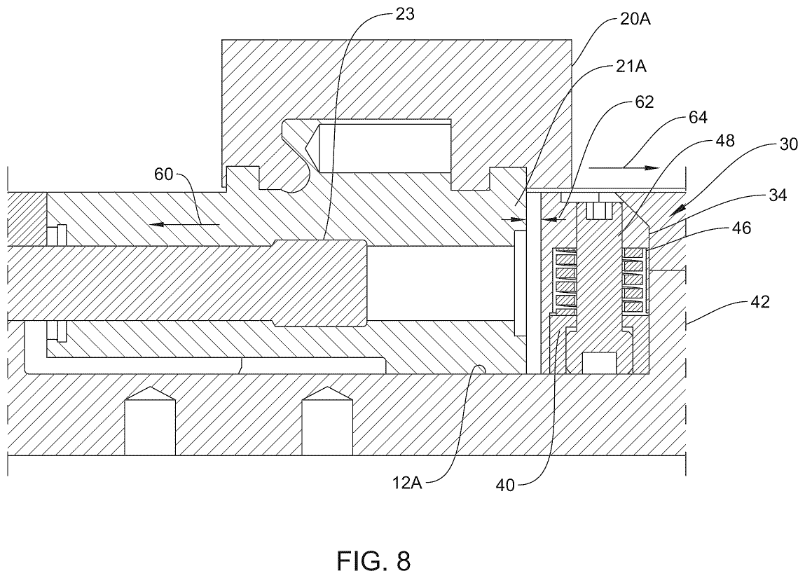

The above described three operating configurations for the friction holding stop 30 are obtainable if the support 34 is securely fastened to the jaw nut 21A or formed integral there with from a singular unitary body. However, if the support 34 is allowed to move relative to the jaw nut 21A, for instance as described above where the support 34 slides on portions 29A of fasteners 29, a preload force on the workpieces can be obtained. Referring to FIG. 8, the actuator 48 is operated so as to achieve the configuration illustrated in FIG. 6 where the friction force between the friction holding stop 30 and the surface 12A is substantially obtained from the friction member 40 being urged against the surface 12A by the spring 46 where such friction force allows the friction holding stop 30 to still move relative to the base 12. In particular, as illustrated in FIG. 8, as the jaw nut 21A is moved relative to the base 12, indicated by arrow 60, by the rotatable screw 23, the friction force of the friction holding stop 30 with the base 12 is sufficient such that a gap 62 is obtained between the facing surfaces of the jaw nut 21A and the friction holding stop 30.

The preload force is obtained from the spring force of springs 33 when compressed. Specifically, as the jaw nut 21 moves away from the friction holding stop 30, indicated by arrow 60, the support 34 slides relative to the fasteners 29 on the smooth portions 29A because the friction member 40 in the direction indicated by arrow 64 has sufficient friction with the base 12 such that the fasteners 29 are pulled through the corresponding bores 34A so as to compress the springs 33. When the handle typically used to rotate the vise screw 23 is released, the springs 33 pull the jaw nut 21B back which creates a preload force upon the workpiece placed between the jaw 20B and the stationary jaw 31 since rotation of the vise screw 23 to achieve the preload sufficiently opened the space between the jaw 20B and the stationary jaw 31 so as to receive the workpiece.

Use of the friction holding stop 30 is particularly useful when the vise 10 is oriented vertically such as in FIG. 2. For purposes of explanation, a lower workpiece station 70A is present between jaw 20A and stationary jaw 31, while an upper workpiece station 70B is present between jaw 20B and stationary jaw 31. In general, during normal vise loading operation, the workpiece between the jaw 20B and the stationary jaw 31 in the upper station 70B will be held in place by the spring force from springs 33 first, then the workpiece loaded between the jaw 20A and the stationary jaw 31 in the lower station 70A will be inserted.

Typically, a configuration step for the vise 10 to set up the positions of the opposing jaw faces of each of the stations 70A and 70B is performed. There are two different methods for configuring the vise 10 so as to have the friction holding stop 30 in the correct position with respect to surface 12A. In a first configuration method, with the friction holding stop 30 configured as in FIG. 6 where the actuator 48 is operated such that the friction member 40 is urged downward by the spring 46 so that friction is created between the portion 42 and the surface 12A but the friction member 40 will slide on surface 12A so as to create gap 62 in FIG. 8, the upper station 70B is loaded with the desired workpiece. The vise screw 23 is then turned so as to clamp the workpiece in the upper station 70B and a desired distance between the jaw faces in the lower station 70A is obtained which is equal to the width of the workpiece for the lower station 70A. However, it should be noted that when the vise screw 23 is turned as to unclamp the workpiece, the gap 62 diminishes and the total distance between the jaw faces of the lower station 70A becomes the desired distance which is the gap 62 and the length of the workpiece to be placed in the lower station 70A.

At this point, if desired, the actuator 48 can be operated so as to increase the friction of the friction holding stop 30 to the base 12 by driving the friction end 58 against the surface 12A.

With the friction holding stop 30 in the correct position for using the lower and upper stations 70A, 70B, the vise screw 23 is rotated so as to open up the jaw faces of the lower station 70A so the initial workpiece can be removed. Expanding the jaw faces of the lower station 70A causes the gap 62 to reduce and causes jaw 20A to contact the friction holding stop 30 because of the springs 33.

In a second configuration method, the actuator 48 is operated so that the friction member 40 is lifted enough such that it will slide freely on surface 12A. This allows the operator to move the vise assembly 19 to have the jaw faces of the upper station 70B to be the length of the workpiece, and the jaw faces of the lower station 70A to be slightly greater than the workpiece to be inserted therein. Then, by turning actuator 48 in the opposite direction, the friction member 40 is allowed to be urged by spring 46 to make contact with surface 12A. The position of the friction holding stop 30 on the surface 12A will be substantially the same as that obtained from the first configuration method but obtained probably faster than via the first configuration method. It should be noted that the jaw 20A is in contact with the friction holding stop 30. If desired, the actuator 48 can be further operated to drive the friction end 58 against the surface 12A.

Via either configuration method, the jaw faces of the upper station 70B are typically still a little too close to allow easy insertion of the workpiece so the vise screw 23 is operated a little more to allow insertion of the workpiece in the upper station 70B. The vise screw 23 is then operated to cause contact of the jaw faces of the upper station 70B to contact that workpiece. At this time, the jaw 20A is in contact with or only slightly pulled away from friction holding stop 30 so that the distance between the jaw faces of the lower station 70A is great enough to allow the workpiece in the lower station 70A to be inserted. Continued rotation of the vise screw 23 causes jaw 20A to be pulled further away from friction holding stop 30 such that the spring force from springs 33 is the preload force between the jaw faces of the upper station 70B. Continued rotation of the vise screw 23 then causes the jaw faces of the lower station 70A to contact its workpiece with rotation then stopped when a sufficient holding force has been obtained upon both of the workpieces.

Upon completion of work upon the workpieces, the vise screw 23 is operated so as to allow removal of the lower station 70A workpiece, but due to the presence of the gap 62 when the lower station 70A workpiece is removed, the preload force is still holding the workpiece in the upper station 70B. Further operation of the vise screw 23 causes the gap 62 to reduce and no longer be present upon contact of the jaw 20A with the friction holding stop 30 such that a little more operation of the vise screw 23 allows the distance of the jaw faces of the upper station 70B to increase allowing removal of the upper station 70B workpiece.

After repeated operation on a number of different sets of workpieces loaded and unloaded from the vise 10, it may become necessary to remove the vise assembly 19 or portions thereof such as vise screw and jaw nuts 21A, 21B to allow cleaning. As indicated above to do so the actuator 48 can be operated to lift the friction member 40 enough or entirely from the surface 12A so as to allow it to slide off the base 12 upon removal of the stop 69.

Although the subject matter has been described in language directed to specific environments, structural features and/or methodological acts, it is to be understood that the subject matter defined in the appended claims is not limited to the environments, specific features or acts described above as has been held by the courts. Rather, the environments, specific features and acts described above are disclosed as example forms of implementing the claims.

Although the present invention has been described with reference to preferred embodiments, workers skilled in the art will recognize that changes may be made in form and detail without departing from the spirit and scope of the invention.

What is claimed is:

1. A vise assembly comprising:
a base;
a pair of side walls extending from the base having guideways, wherein inwardly facing surfaces of the base and the pair of side walls form a center recess;
a jaw configured for guided movement by the guideways; and
a friction holding stop secured to the jaw configured to selectively and frictionally engage a surface of the base and inhibit sliding movement of the jaw on the guideways, the friction holding stop comprising:
a support secured to the jaw, the support including a cavity opening toward the surface of the base;
a member disposed within the cavity and movable toward and away from the surface, the member having a portion engageable with the surface of the base;
a spring configured to urge the member toward the surface of the base; and
an actuator coupled to the member and the support, the actuator configured to selectively move the member away from the surface against a spring force from the spring.

2. The vise assembly of claim 1 wherein the member comprises a recess extending into from the portion.

3. The vise assembly of claim 2 wherein the member comprises a bore extending through the member and opening to the recess, wherein the actuator extends through the bore.

4. The vise assembly of claim 3 wherein the actuator includes a friction end configured to selectively engage a surface of the base.

5. The vise assembly of claim 4 wherein the actuator is operated on an end opposite the friction end to selectively engage the surface of the base.

6. The vise assembly of claim 5 wherein the actuator is a threaded bolt threadably engaging the support.

7. The vise assembly of claim 1 wherein the cavity includes an inwardly extending flange, the member of size to engage the inwardly extending flange with the portion being spaced apart from a surface of the base.

8. A vise assembly comprising:
a base;
a pair of side walls extending from the base having guideways, wherein inwardly facing surfaces of the base and the pair of side walls form a center recess;
a first jaw configured for guided movement by the guideways;
a second jaw facing in a direction toward the first jaw and configured for guided movement of the guideways; and
a friction holding stop configured to selectively and frictionally engage a surface of the base and inhibit sliding movement of the first jaw on the guideways, the friction holding stop having:
a bore;
a spring; and
a fastener extending through the bore and securing the friction holding stop to the first jaw on a side opposite the second jaw, the friction holding stop configured to slide on the fastener away from the first jaw and compress the spring.

9. The vise assembly of claim 8 wherein the friction holding stop comprises a support, the support being slidable on the fastener.

10. The vise assembly of claim 9 wherein the bore opens to a cavity in the support on a side opposite the jaw, the spring being disposed in the cavity.

11. The vise assembly of claim 10 wherein the friction holding stop comprises a second bore spaced apart from the bore, and the vise assembly further comprises:
a second spring; and
a second fastener extending through the second bore and securing the friction holding stop to the first jaw on a side opposite the second jaw, the friction holding stop configured to slide on the second fastener away from the first jaw and compress the spring.

12. The vise assembly of claim 11 wherein the support includes a cavity opening toward the surface of the base, the friction holding stop comprising;
a member disposed within the cavity and movable toward and away from the surface, the member having a portion engageable with the surface of the base;
a second spring configured to urge the member toward the surface of the base; and
an actuator coupled to the member and the support, the actuator configured to selectively move the member away from the surface against a spring force from the second spring.

13. The vise assembly of claim 12 wherein the member comprises a recess extending into from the portion.

14. The vise assembly of claim 13 wherein the member comprises a bore extending through the member and opening to the recess, wherein the actuator extends through the bore.

15. The vise assembly of claim 14 wherein the actuator includes a friction end configured to selectively engage the surface of the base.

16. The vise assembly of claim 15 wherein the actuator is operated on an end opposite the friction end to selectively engage the surface of the base.

17. The vise assembly of claim 16 wherein the actuator is a threaded bolt threadably engaging the support.

18. The vise assembly of claim 12 wherein the cavity includes an inwardly extending flange, the member of size to engage the inwardly extending flange with the portion being spaced apart from the surface of the base.
